(19) United States
(12) Patent Application Publication
(10) Pub. No.: US 2026/0218828 A1
(43) Pub. Date: Jul. 30, 2026

(54) MOUNTING ASSEMBLY FOR FLUID-TRANSFER PLUG

(71) Applicant: Microsoft Technology Licensing, LLC, Redmond, WA (US)

(72) Inventor: Errol Mark TAZBAZ, Bellevue, WA (US)

(73) Assignee: Microsoft Technology Licensing, LLC, Redmond, WA (US)

(21) Appl. No.: 19/041,431

(22) Filed: Jan. 30, 2025

(51) Int. Cl. F16L 37/60; F16L 3/08

(52) U.S. Cl. CPC F16L 37/60; F16L 3/08

(57) ABSTRACT

A mounting assembly for a fluid-transfer plug comprises a mounting receptacle comprising proximal left and right retention surfaces and distal left and right retention surfaces. A support surface includes an alignment aperture, and a locking member is located between the proximal and distal left retention surfaces. A housing for the plug is removably secured in the mounting receptacle. The housing comprises a housing body and left and right locking slots. An alignment pin extends from a bottom surface into the alignment aperture of the mounting receptacle. The locking member of the mounting receptacle extends into the left locking slot to removable secure the housing and plug in the mounting receptacle.

### BACKGROUND

Some fluid supply lines utilize fluid-transfer plugs. When different fluid flow rates are desired, differently-sized fluid-transfer plugs and plug mounting assemblies are utilized.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed and further described below that relate to mounting assemblies for fluid-transfer plugs. In one example and as described below, a mounting assembly for a fluid-transfer plug comprises a mounting receptacle comprising proximal left and right retention surfaces and distal left and right retention surfaces. The mounting receptacle includes a support surface comprising an alignment aperture, and a locking member located between the proximal left retention surface and the distal left retention surface.

A housing for the fluid-transfer plug is removably secured in the mounting receptacle. The housing comprises a housing body, a left locking slot defined in a left side of the housing body, and a right locking slot defined in a right side of the housing body. An alignment pin extends from a bottom surface of the housing body into the alignment aperture in the support surface of the mounting receptacle. The locking member of the mounting receptacle extends into the left locking slot in the left side of the housing body to removable secure the housing and fluid-transfer plug in the mounting receptacle.

### BRIEF DESCRIPTION OF THE DRAWINGS

FIG. 1A shows portions of a mounting assembly for a fluid-transfer plug according to one example of the present disclosure.

FIG. 1B shows an enlarged end view of the mounting assembly of FIG. 1.

FIG. 2 shows an exploded view of the mounting assembly of FIG. 1.

FIG. 3 shows a partial exploded view of the mounting assembly of FIG. 1 including the bracket of the mounting receptacle and the housing enclosing a portion of the fluid-transfer plug.

FIG. 4 shows a rotated view of the partial exploded view of the mounting assembly of FIG. 3.

FIG. 5 shows a partial exploded view of a mounting assembly for a fluid-transfer plug according to another example of the present disclosure.

FIG. 6 shows the mounting assembly of FIG. 1 being inserted into the bracket of the mounting receptacle.

FIG. 7 shows the mounting assembly of FIG. 1 seated and removably secured in the bracket of the mounting receptacle.

FIG. 8 shows a cross-section taken along line 8-8 of FIG. 7.

FIG. 9 shows a cross-section taken along line 9-9 of FIG. 7.

### DETAILED DESCRIPTION

Fluid delivery systems, such as cooling systems for data center hardware, can utilize plugs and corresponding sockets for connecting and disconnecting fluid supply lines. In some examples, a fluid-transfer plug extends from the chassis of a modular computing unit, such as a blade server, and is received in a corresponding socket. In some examples improper matings of plugs and sockets can disrupt fluid transfer. Accordingly, each plug is carefully mounted and located within its corresponding modular computing unit to be aligned with its corresponding socket.

In some examples, these fluid delivery systems require changes in plug diameters when different fluid transfer rates and volumes are needed. These changes then require corresponding changes in mounting hardware for the plug to ensure proper alignment is maintained, which correspondingly increases the complexity, cost and time required to change a fluidic coupling size.

Accordingly and as described in more detail below, the present disclosure describes mounting assemblies for fluid-transferring plugs that overcome one or more of the disadvantages described above. Advantageously, mounting assemblies of the present disclosure include an easily removable plug housing that provides built-in alignment and locking features. Additionally, the plug housing and corresponding mounting receptacle enable tool-less, drop-in installation and removal of the housing to facilitate simple and fast changes of differently-sized plugs. Further, mounting assemblies of the present disclosure enable an interchangeable family of plug sizes within a fixed housing size, thereby greatly simplifying the process of changing a fluidic coupling size. Additionally, the configuration of the plug housing allows mirror image versions of the housing to fit into both left and right-handed mounting receptacles.

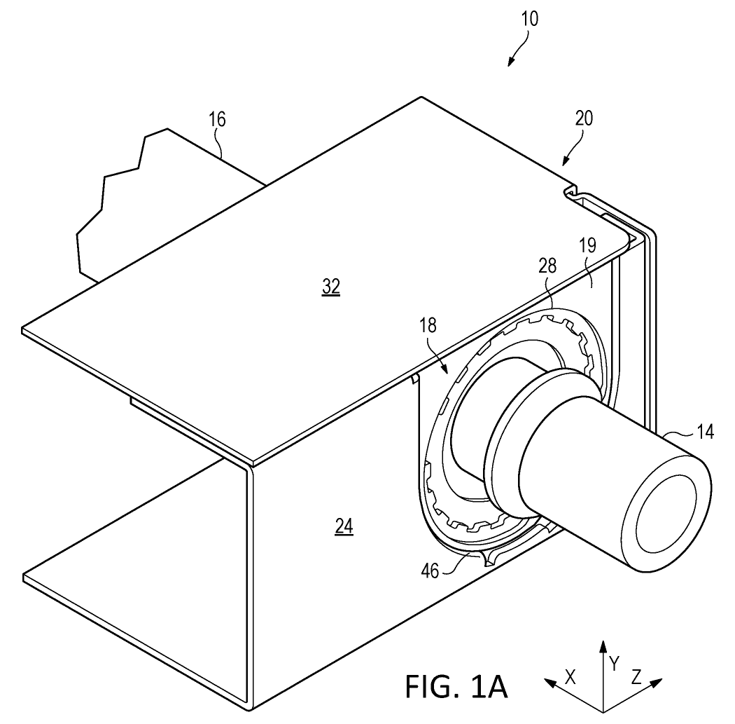

FIGS. 1-4 and 6-9 show one example of a mounting assembly 10 for a fluid-transfer plug 14 according to aspects of the present disclosure. In the present example plug 14 is configured to be coupled to a hose 16 at a distal end and removably mated with a socket (not shown) at a proximal end. It will be appreciated that the principles of the present disclosure can be utilized in other configurations of fluid-transferring plugs having different form factors, capabilities, components, and/or other features.

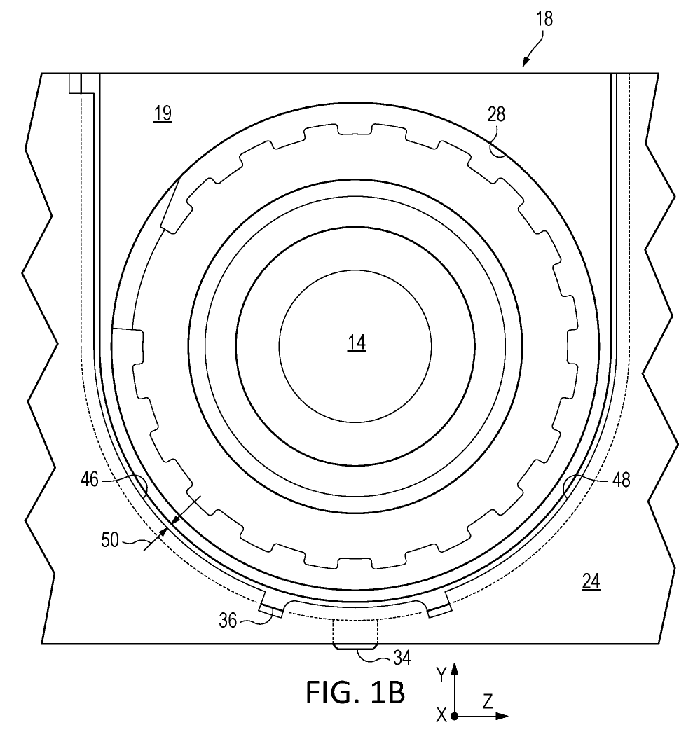

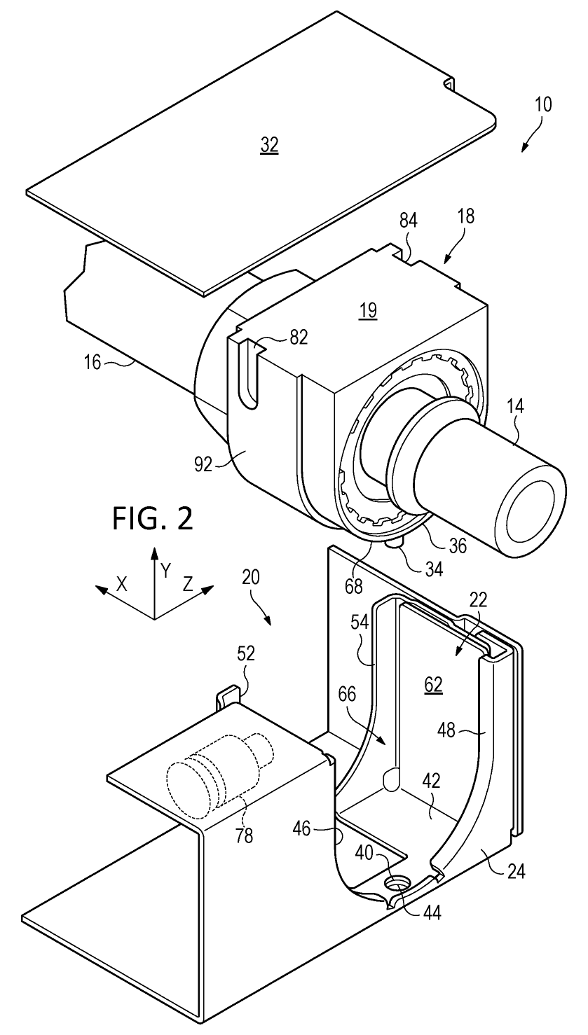

In the present example with reference also to FIG. 2 and as described further below, plug 14 is contained in a housing 18 that is mounted and removably secured in a mounting receptacle 20. In the present example and with reference also to FIG. 3, mounting receptacle 20 comprises a bracket 22 and a chassis 24 within a modular computing unit, such as a blade server. In the present example bracket 22 is affixed to chassis 24 via fasteners (not shown). In other examples bracket 22 can be affixed to chassis 24 via any other suitable material joining or bonding technique. For clarity of description purposes, FIGS. 3-9 show bracket 22 without chassis 24. In some examples chassis 24 is mounted internally within another chassis of the modular computing unit.

With reference again to FIG. 1A, plug 14 is mounted such that its proximal end extends from an aperture 28 in the housing body 19 of housing 18 for insertion into a corresponding socket. In some examples, plug 14 includes a moving seal configured to move axially in the X-axis direction when the plug is mated with a corresponding socket, to thereby allow fluid flow through the plug. Cover 32 is removable to allow easy access to, and insertion/removal of, the housing 18 and plug 14.

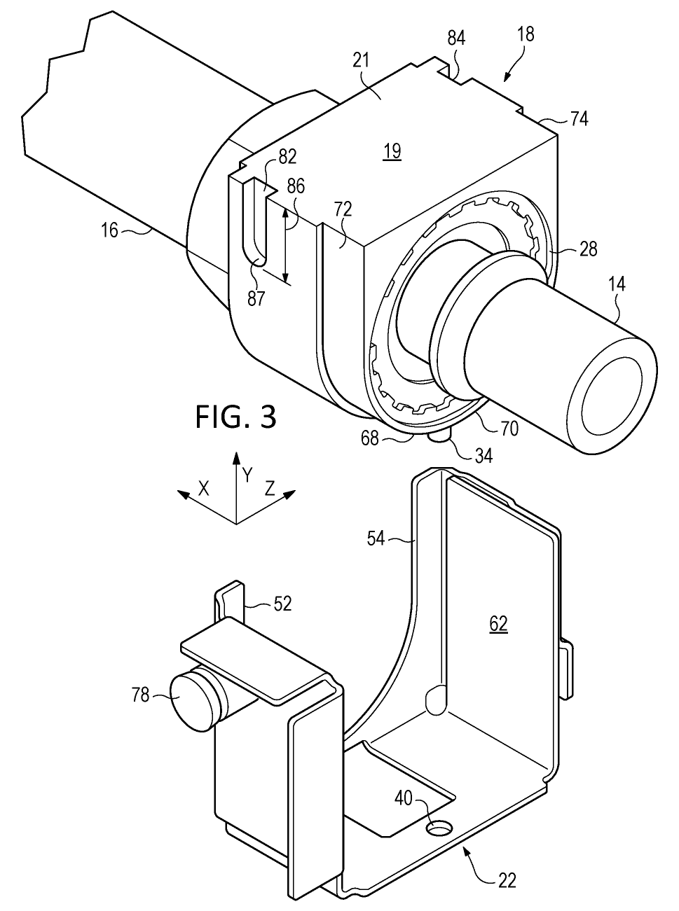

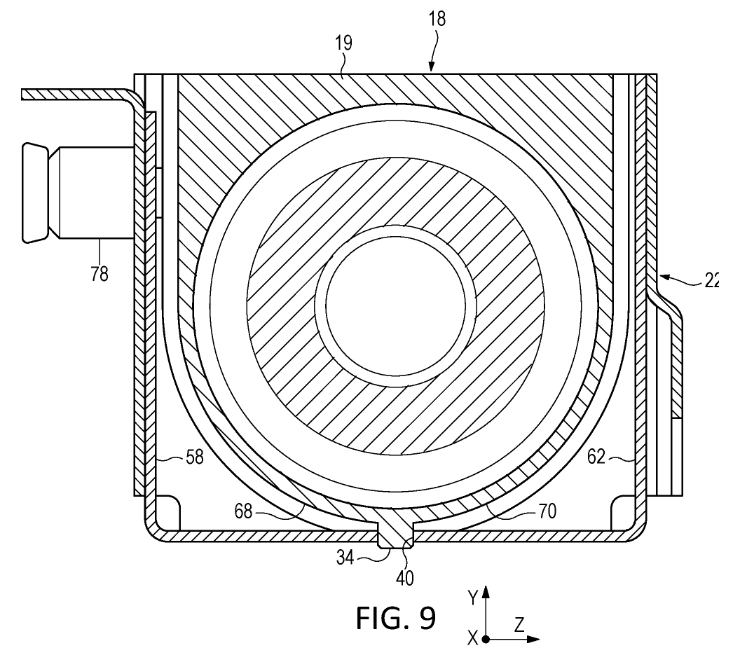

As noted above and in one potential advantage of the present disclosure, the removable housing 18 and mounting receptacle 20 include built-in alignment and locking features that enable tool-less, drop-in installation and removal of the housing and enclosed plug 14 while maintaining tight tolerances to ensure proper alignment of the plug. More particularly and with reference to FIG. 2, in the present example housing 18 includes an alignment pin 34 extending from a bottom surface 36 of the housing body 19. With reference also to FIG. 9, bottom surface 36 of housing body 19 comprises a left arcuate portion 68 and a right arcuate portion 70, with the alignment pin 34 extending from between the left arcuate portion and the right arcuate portion. With reference to FIGS. 3 and 4, a left side of housing body 19 comprises a left planar surface 72 that transitions into the left arcuate portion 68 of housing body, and a right side of housing body comprises a right planar surface 74 that transitions into the right arcuate portion 70 of housing body.

As described further below, when the housing 18 is inserted into mounting receptacle 20, guiding features of the housing and mounting receptacle guide the alignment pin 34 into a bracket alignment aperture 40 defined in a support surface 42 of the bracket 22 of the mounting receptacle (see FIG. 9). In the present example and with reference to FIG. 2, chassis 24 includes a chassis alignment aperture 44 that is aligned with bracket alignment aperture 40.

In the present example, and in one potential advantage of the present configuration, when alignment pin 34 is received in bracket alignment aperture 40, these features cooperate to substantially secure housing 18 and enclosed plug 14 from lateral movement in the X- or Z-axis directions. In some examples alignment pin 34 is received in bracket alignment aperture 40 with an interference fit.

As noted above, when housing 18 is inserted into mounting receptacle 20, guiding features guide insertion of the housing into the mounting receptacle. Additionally and as described further below, the guiding features also function to substantially constrain housing 18 and enclosed plug 14 from rotation or translation about the X-, Y-, and Z-axes. More particularly and with reference to FIGS. 1B, 2, and 4, chassis 24 of mounting receptacle 20 comprises a proximal left retention surface 46 and opposing proximal right retention surface 48.

Bracket 22 of mounting receptacle 20 comprises a distal left retention surface 52 and opposing distal right retention surface 54, with the distal left retention surface longitudinally spaced along the X-axis from the proximal left retention surface 46, and the distal right retention surface longitudinally spaced along the X-axis from the proximal right retention surface 48. Bracket 22 further comprises a left sidewall 58 between the proximal left retention surface 46 and the distal left retention surface 52 (see FIGS. 2 and 4), and a right sidewall 62 between the proximal right retention surface 48 and the distal right retention surface 54. The left sidewall 58 and right sidewall 62 define a cavity 66 therebetween.

In another potential advantage of the present disclosure, with housing 18 seated in mounting receptacle 20 as shown in FIGS. 1A and 1B, the arcuate proximal left retention surface 46 and proximal right retention surface 48 substantially angularly constrain housing body 19 and enclosed plug 14 from rotation about the Y-axis. In the present example, when housing body 19 is seated in mounting receptacle 20 the arcuate proximal left retention surface 46 and proximal right retention surface 48 are spaced from the outer surface of housing body 19 by a small gap 50 (see FIG. 1B), such as 0.2 mm. In other examples, when housing 18 is seated in mounting receptacle 20 the arcuate proximal left retention surface 46 and proximal right retention surface 48 can be substantially flush with the outer surface of housing body 19. In a similar manner, when housing body 19 is seated in mounting receptacle 20 the arcuate distal left retention surface 52 and distal right retention surface 54 are spaced from the outer surface of housing body 19 by the small gap. In other examples, when housing body 19 is seated in mounting receptacle 20, the arcuate distal left retention surface 52 and distal right retention surface 54 can be substantially flush with the outer surface of housing body 19. Advantageously, these configurations provide tight tolerance control by substantially angularly constraining housing body 19 and enclosed plug 14 from rotation about the Y-axis.

In another potential advantage of the present disclosure, and as described in more detail below, mounting receptacle 20 comprises a movable locking member configured to substantially constrain movement of the housing 18 and plug 14 in the Y-axis direction, as well as in the X- and Z-axis directions. With reference to FIGS. 2-4, in the present example the locking member comprises a spring-loaded plunger 78 located between the proximal left retention surface 46 and the distal left retention surface 52. In other examples, other configurations of locking members can be utilized, including but not limited servo motor actuators and electromagnetic actuators.

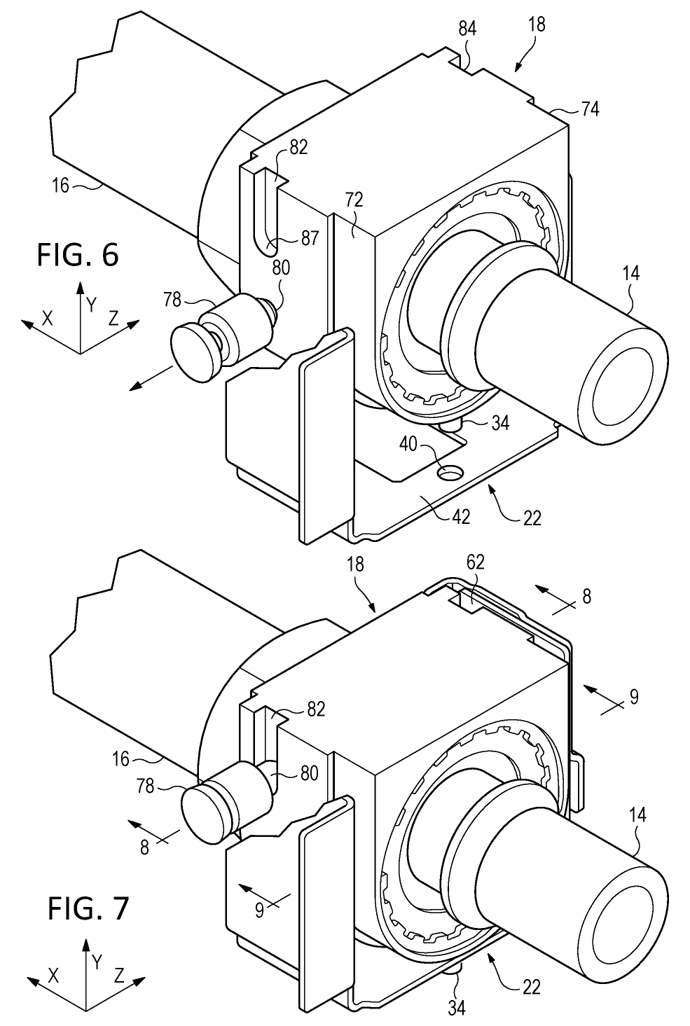

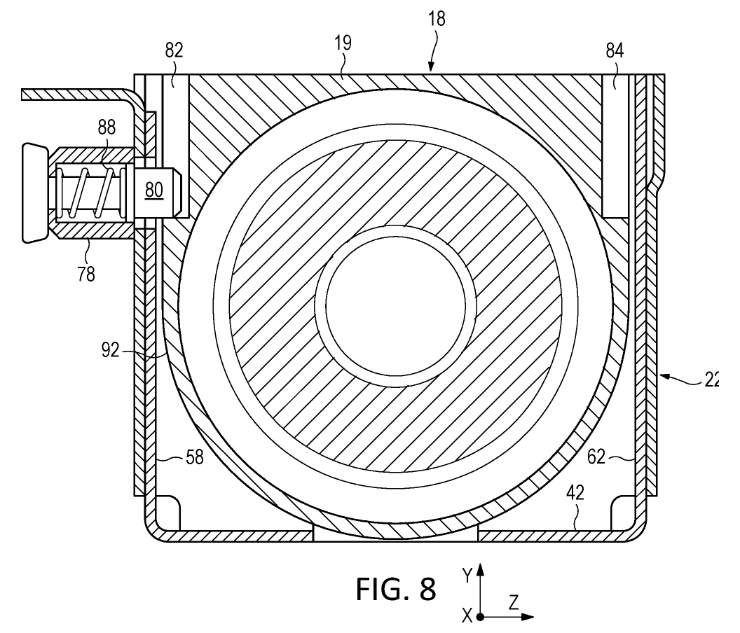

As described in more detail below and as shown in FIGS. 7 and 8, when housing 18 and enclosed plug 14 are removably secured in mounting receptacle 20, projection 80 of plunger 78 extends through the left sidewall 58 of mounting receptacle 20 into a left locking slot 82 defined in a left side of the housing body 19. In this manner, plunger 78 locks housing 18 and enclosed plug 14 into mounting receptacle 20 and substantially constrains movement of the housing and plug in the Y-axis direction, as well as in the X- and Z-axis directions.

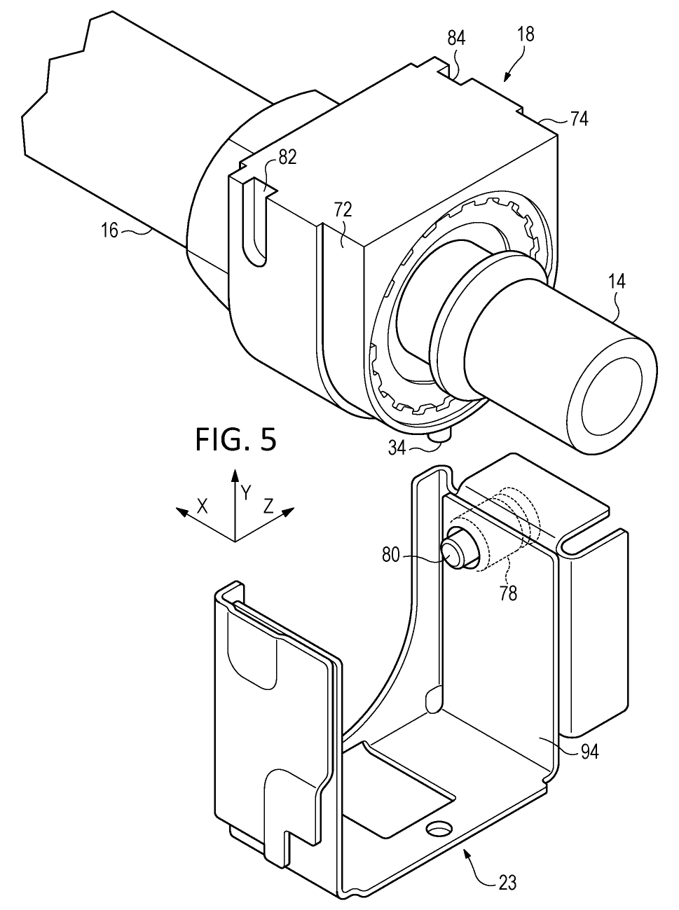

Additionally, and in another potential advantage of the present disclosure, plunger 78 is biased to extend into the left locking slot 82 in the left side of the housing body 19. In the present example and with reference to FIG. 8, plunger 78 comprises a biasing spring 88 that biases projection 80 in the Z-axis direction. Advantageously, this configuration enables tool-less, drop-in installation and removal of the housing 18 to facilitate simple and fast servicing of the installed plug or exchanging an installed plug for a differently sized plug without changing any of the chassis or receptable sheet metal parts.. More particularly and with reference to FIGS. 6 - 8, as housing 18 is lowered into mounting receptacle 20, a distal arcuate portion 92 of housing body 19 slides along and translates projection 80 in the negative Z-axis direction as the body moves in the negative Y-axis direction into the receptacle. As shown in FIGS. 7 and 8, when the bottom surface 87 of left locking slot 82 passes below projection 80, biasing spring 88 translates the projection into the left locking slot to secure housing 18 and plug 14 within bracket 22 of mounting receptacle 20. Additionally, housing 18 and plug 14 can be easily removed from mounting receptacle 20 by retracting projection 80 and sliding the housing and plug out from the receptacle.

As noted above and in another potential advantage, mounting assemblies of the present disclosure enable an easily interchangeable family of plug sizes within a given housing size, while also preserving tight tolerances to ensure proper alignment of the plug. In this manner, multiple plugs with different bore diameters can be utilized in the same housing 18 that is removably secured in the same chassis 24, such as a 1 RU (rack unit) height chassis (equal to 44.45 mm), thereby enabling easy modification of flow volumes by using a different plug having a different bore diameter. Accordingly, the present configurations enable quick and easy replacement of different plug sizes without requiring costly and time-consuming modifications of mounting hardware, thereby greatly simplifying the process of changing fluid flow rates.

With reference again to FIG. 3, left locking slot 82 and right locking slot 84 extend through a top surface 21 of housing body 19. Left locking slot 82 has a slot length 86 from top surface 21 of housing body 19 to the left slot bottom surface 87. Similarly and with reference to FIG. 4, right locking slot 84 has the same slot length 86 from top surface 21 of housing body 19 to a right slot bottom surface 89. Additionally, the left locking slot 82 is laterally aligned along the Z-axis with the right locking slot 84.

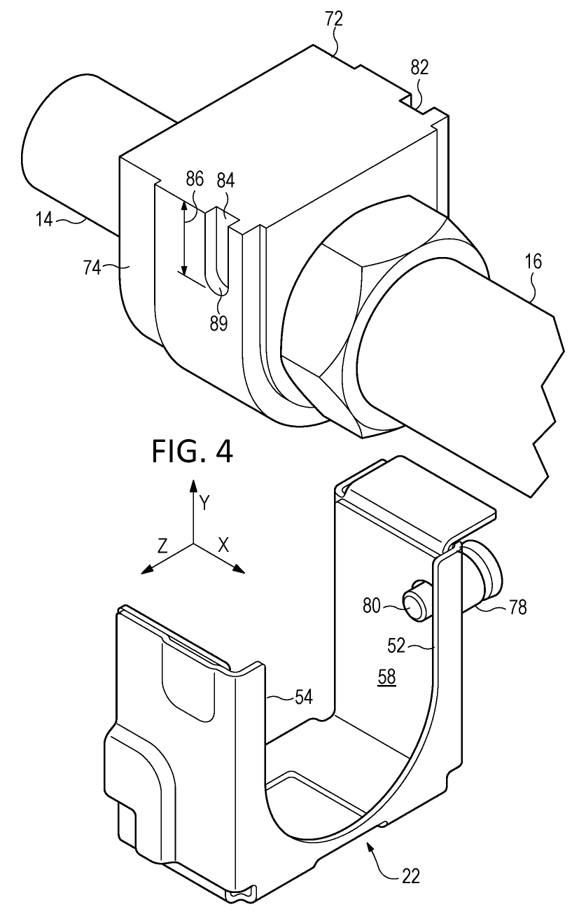

Advantageously, this configuration enables the housing 18 and enclosed plug 14 to be utilized with mounting receptacles having the plunger 78 on the opposite side of the bracket, while allowing the housing and plug to remain in the same orientation relative to the mounting receptacle and other surrounding structures. In one example and with reference now to FIG. 5, a mirror image bracket 23 can be utilized with housing 18 and enclosed plug 14, with bracket 23 including plunger 78 and projection 80 extending through a right sidewall 94 of bracket 23. In this manner, when housing 18 and enclosed plug 14 are translated downwardly into bracket 23, projection 80 extends into the right locking slot 84 in the right side of the housing body 19. Advantageously, this configuration of housing 18 can be utilized with mounting receptacles having the plunger 78 on either side of the bracket, thereby enabling the same housing to be utilized with different mounting receptacles at different locations in the surrounding device structure, such as on opposite sides of the device.

The following paragraphs provide additional support for the claims of the subject application. One aspect provides a mounting assembly for a fluid-transfer plug, the mounting assembly comprising: a mounting receptacle comprising: a proximal left retention surface and opposing proximal right retention surface; a distal left retention surface and opposing distal right retention surface; a support surface comprising an alignment aperture defined in thesupport surface; and a movable locking member located between the proximal left retention surface and the distal left retention surface; and a housing for the fluid-transfer plug, the housing removably secured in the mounting receptacle, the housing comprising: a housing body; a left locking slot defined in a left side of the housing body; a right locking slot defined in a right side of the housing body opposite to the left side; and an alignment pin extending from a bottom surface of the housing body into the alignment aperture in the support surface of the mounting receptacle, wherein the locking member of the mounting receptacle extends into the left locking slot in the left side of the housing body. The mounting assembly additionally or alternative includes a left sidewall between the proximal left retention surface and the distal left retention surface of the mounting receptacle; and a right sidewall between the proximal right retention surface and the distal right retention surface of the mounting receptacle. The mounting assembly may additionally or alternative include, wherein the movable locking member comprises a plunger extending through the left sidewall of the mounting receptacle into the left locking slot in the left side of the housing body. The mounting assembly may additionally or alternative include, wherein the plunger is biased to extend into the left locking slot in the left side of the housing body. The mounting assembly may additionally or alternative include, wherein the mounting receptacle comprises: a chassis that comprises the proximal left retention surface and the opposing proximal right retention surface; and a bracket that comprises the distal left retention surface and the opposing distal right retention surface, wherein the bracket is affixed to the chassis. The mounting assembly may additionally or alternative include, wherein the bracket comprises the support surface that includes the alignment aperture. The mounting assembly may additionally or alternative include, wherein the left locking slot in the left side of the housing body is laterally aligned with the right locking slot in the right side of the housing body. The mounting assembly may additionally or alternative include, wherein the bottom surface of the housing body comprises a left arcuate portion and a right arcuate portion, wherein the alignment pin extends from between the left arcuate portion and the right arcuate portion.

Another aspect provides a housing for a fluid-transfer plug, the housing comprising: a housing body; a left locking slot defined in a left side of the housing body; a right locking slot defined in a right side of the housing body opposite to the left side; and an alignment pin extending from a bottom surface of the housing body. The housing may additionally or alternatively include, wherein the left locking slot is laterally aligned with the right locking slot. The housing may additionally or alternatively include, wherein the left locking slot extends through a top surface of the housing body and the right locking slot extends through the top surface of the housing body. The housing may additionally or alternatively include, wherein the left locking slot has a slot length from the top surface of the housing body to a left slot bottom surface, and the right slot has the slot length from the top surface of the housing body to a right slot bottom surface. The housing may additionally or alternatively include, wherein the bottom surface of the housing body comprises a left arcuate portion and a right arcuate portion, wherein the alignment pin extends from between the left arcuate portion and the right arcuate portion. The housing may additionally or alternatively include, wherein a left side of the housing body comprises a left planar surface that transitions into the left arcuate portion of the housing body, and a right side of the housing body comprises a right planar surface that transitions into the right arcuate portion of the housing body.

Another aspect provides a mounting receptacle configured to removably secure a housing for a fluid-transfer plug, the mounting receptacle comprising: a proximal left retention surface and opposing proximal right retention surface; a distal left retention surface and opposing distal right retention surface, the distal left retention surface spaced from the proximal left retention surface, and the distal right retention surface spaced from the proximal right retention surface; a support surface comprising an alignment aperture defined in the support surface; and a movable locking member located between either the proximal left retention surface and the distal left retention surface or between the proximal right retention surface and the distal right retention surface. The mounting receptacle may additionally or alternatively include a left sidewall between the proximal left retention surface and the distal left retention surface, and a right sidewall between the proximal right retention surface and the distal right retention surface. The mounting receptacle may additionally or alternatively include, wherein the movable locking member comprises a plunger extending through either the left sidewall or the right sidewall. The mounting receptacle may additionally or alternatively include, wherein the plunger is biased to extend into a cavity defined between the left sidewall and the right sidewall. The mounting receptacle may additionally or alternatively include, wherein a chassis comprises the proximal left retention surface and opposing proximal right retention surface, a bracket comprises the distal left retention surface and opposing distal right retention surface, and the bracket is affixed to the chassis. The mounting receptacle may additionally or alternatively include, wherein the bracket comprises the support surface that defines the locking aperture.

"And/or" as used herein is inclusive and means either one or both of the items/conditions connected by the phrase. In other words, when A "and/or" B is used, it means A alone, or B alone, or both A and B together.

The terms “left”, “right”, and the like as used herein, which denote relative spatial positions, describe the relationship of a component relative to another component in the accompanying drawings for the purpose of illustration and are not intended to limit the configurations to particular orientations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In the descriptions provided herein, ordinal numbers such as first and second are used for convenience and ease of description, and do not denote any order or arrangement of components.

The subject matter of the present disclosure includes all novel and non-obvious combinations and sub-combinations of the various processes, systems and configurations, and other features, functions, acts, and/or properties disclosed herein, as well as any and all equivalents thereof.

1. A mounting assembly for a fluid-transfer plug, the mounting assembly comprising:
a mounting receptacle comprising:
a proximal left retention surface and opposing proximal right retention surface;
a distal left retention surface and opposing distal right retention surface;
a support surface comprising an alignment aperture defined in thesupport surface; and
a movable locking member located between the proximal left retention surface and the distal left retention surface; and
a housing for the fluid-transfer plug, the housing removably secured in the mounting receptacle, the housing comprising:
a housing body;
a left locking slot defined in a left side of the housing body;
a right locking slot defined in a right side of the housing body opposite to the left side; and
an alignment pin extending from a bottom surface of the housing body into the alignment aperture in the support surface of the mounting receptacle,
wherein the locking member of the mounting receptacle extends into the left locking slot in the left side of the housing body.

2. The mounting assembly of claim 1, further comprising:
a left sidewall between the proximal left retention surface and the distal left retention surface of the mounting receptacle; and
a right sidewall between the proximal right retention surface and the distal right retention surface of the mounting receptacle.

3. The mounting assembly of claim 2, wherein the movable locking member comprises a plunger extending through the left sidewall of the mounting receptacle into the left locking slot in the left side of the housing body.

4. The mounting assembly of claim 3, wherein the plunger is biased to extend into the left locking slot in the left side of the housing body.

5. The mounting assembly of claim 1, wherein the mounting receptacle comprises:
a chassis that comprises the proximal left retention surface and the opposing proximal right retention surface; and
a bracket that comprises the distal left retention surface and the opposing distal right retention surface, wherein the bracket is affixed to the chassis.

6. The mounting assembly of claim 5, wherein the bracket comprises the support surface that includes the alignment aperture.

7. The mounting assembly of claim 1, wherein the left locking slot in the left side of the housing body is laterally aligned with the right locking slot in the right side of the housing body.

8. The mounting assembly of claim 1, wherein the bottom surface of the housing body comprises a left arcuate portion and a right arcuate portion, wherein the alignment pin extends from between the left arcuate portion and the right arcuate portion.

9. A housing for a fluid-transfer plug, the housing comprising:
a housing body;
a left locking slot defined in a left side of the housing body;
a right locking slot defined in a right side of the housing body opposite to the left side; and
an alignment pin extending from a bottom surface of the housing body.

10. The housing of claim 9, wherein the left locking slot is laterally aligned with the right locking slot.

11. The housing of claim 9, wherein the left locking slot extends through a top surface of the housing body and the right locking slot extends through the top surface of the housing body.

12. The housing of claim 11, wherein the left locking slot has a slot length from the top surface of the housing body to a left slot bottom surface, and the right slot has the slot length from the top surface of the housing body to a right slot bottom surface.

13. The housing of claim 9, wherein the bottom surface of the housing body comprises a left arcuate portion and a right arcuate portion, wherein the alignment pin extends from between the left arcuate portion and the right arcuate portion.

14. The housing of claim 13, wherein a left side of the housing body comprises a left planar surface that transitions into the left arcuate portion of the housing body, and a right side of the housing body comprises a right planar surface that transitions into the right arcuate portion of the housing body.

15. A mounting receptacle configured to removably secure a housing for a fluid-transfer plug, the mounting receptacle comprising:
a proximal left retention surface and opposing proximal right retention surface;
a distal left retention surface and opposing distal right retention surface, the distal left retention surface spaced from the proximal left retention surface, and the distal right retention surface spaced from the proximal right retention surface;
a support surface comprising an alignment aperture defined in the support surface; and
a movable locking member located between either the proximal left retention surface and the distal left retention surface or between the proximal right retention surface and the distal right retention surface.

16. The mounting receptacle of claim 15, further comprising a left sidewall between the proximal left retention surface and the distal left retention surface, and a right sidewall between the proximal right retention surface and the distal right retention surface.

17. The mounting receptacle of claim 16, wherein the movable locking member comprises a plunger extending through either the left sidewall or the right sidewall.

18. The mounting receptacle of claim 17, wherein the plunger is biased to extend into a cavity defined between the left sidewall and the right sidewall.

19. The mounting receptacle of claim 15, wherein a chassis comprises the proximal left retention surface and opposing proximal right retention surface, a bracket comprises the distal left retention surface and opposing distal right retention surface, and the bracket is affixed to the chassis.

20. The mounting receptacle of claim 19, wherein the bracket comprises the support surface that defines the locking aperture.
